(19) United States
(12) Patent Application Publication
(10) Pub. No.: US 2008/0178912 A1
(43) Pub. Date: Jul. 31, 2008

(54) AGRICULTURAL STERILIZING AND DETOXIFYING ASSEMBLY FOR VEGETABLES AND FRUIT

(75) Inventor: Kuo Kang Chen, Taipei (TW)

Correspondence Address: LaRiviere, Grubman & Payne, LLP, P.O. Box 3140, Monterey, CA, 93942, US

(73) Assignee: Rosace International Co., Ltd., Taipei (TW)

(21) Appl. No.: 11/627,869

(22) Filed: Jan. 26, 2007

(51) Int. Cl. B08B 3/04

(52) U.S. Cl. 134/104.3

(57) ABSTRACT

An agricultural sterilizing and detoxifying assembly for vegetables and fruit has a rough-washing tank, a re-washing tank, a water-clarifying assembly and a sterilizing assembly. The rough-washing tank holds vegetables and fruit to be washed for the first time. The re-washing tank communicates with the rough-washing tank and holds vegetables and fruit to be washed again. The sterilizing assembly provides purified water to the re-washing tank and the water-clarifying assembly. Purified water is full of ozone, free radicals and emulsified bubbles to breakdown insecticides and to destroy microorganisms adhering to the vegetables and fruit. Sediment and wastewater can flow to the water-clarifying assembly to be purified, and purified water will flow back to the re-washing tank and rough-washing tank to recycle the water.

### BACKGROUND OF THE INVENTION

1. Field of Invention

The present invention relates to an agricultural sterilizing and detoxifying assembly for vegetables and fruit, and more particularly to an agricultural assembly that can sterilize and detoxify vegetables and fruit and recycle used water.

2. Description of the Related Art

Generally, millions of microorganisms parasitize crops such as vegetables and fruit on farms. More than ten kinds of microorganisms parasitize fruit, such as Cladosporium, Aspergillus, Fusarium, Penicillium, Alternaria, Rhizopus, Mucor, Saccharomyces and Staphylococcus aureus. More than twenty kinds of microorganisms parasitize vegetables and flowers, such as Erwinia, Bacillus, Aerobacter, Flavobacterium, Alcaligenes, Cellulomonas, Chromobacterium, Streptococcus, Leuconstoc, Lactobacillus, Micrococcus, Nisseria, Pseudmonas, Mycobacterium, Phytomonas, Sarcina, Seratia, Staphylococcus and Vibrio.

Thus, farmers spray various insecticides to prevent blight from striking corps and to ensure good harvests. Because the insecticides adhere to the fruit and vegetables, people must wash the fruit and vegetables before eating them. However, after fruit or vegetables have been washed repeatedly in a container of water, the insecticide cannot be removed thoroughly. The residual insecticide will harm people's bodies and cause disease or chronic disease.

Moreover, the vegetables and fruit decay at a rate proportional to how many microorganisms parasitize the vegetables and fruit. If vegetables and fruit can be sterilized before they are refrigerated, transported or stored, they will stay fresh for a long time.

Furthermore, tap water is generally used to wash the vegetables and fruit, but wastewater with the insecticides flow directly into a sewer and pollute the environment.

To overcome the shortcomings, the present invention provides an agricultural sterilizing and detoxifying assembly for vegetables and fruit to mitigate or obviate the aforementioned.

### SUMMARY OF THE INVENTION

The primary objective of the present invention is to provide an agricultural sterilizing and detoxifying assembly for vegetables and fruit, which can sterilize and detoxify vegetables and fruit and recycle wastewater.

To achieve the objective, the agricultural sterilizing and detoxifying assembly in accordance with the present invention for vegetables and fruit has a rough-washing tank, a re-washing tank, a water-clarifying assembly and a sterilizing assembly. The rough-washing tank holds vegetables and fruit to be washed the first time. The re-washing tank communicates with the rough-washing tank and holds vegetables and fruit to be washed again. The sterilizing assembly provides purified water to the re-washing tank and the water-clarifying assembly. The purified water is full of ozone, free radicals and emulsified bubbles to breakdown insecticides and destroy microorganisms adhering to the vegetables and fruit. Suspended sediment and wastewater flow to the water-clarifying assembly to be purified, and purified water is pumped back to the re-washing tank and the rough-washing tank, so water can be recycled.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an agricultural sterilizing and detoxifying assembly for vegetables and fruit in accordance with the present invention;

FIG. 2 is a piping diagram of a rough-washing tank, a re-washing tank and a packing platform of the agricultural sterilizing and detoxifying assembly in FIG. 1;

FIG. 3 is an enlarged side view of the rough-washing tank in FIG. 2; and

FIG. 4 is a piping diagram of the water-clarifying assembly in FIG. 1.

### DETAILED DESCRIPTION OF THE INVENTION

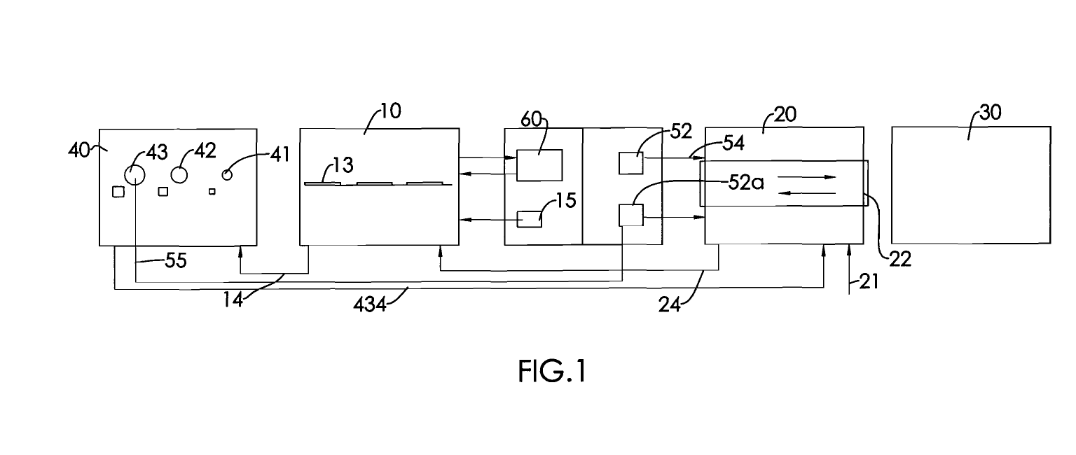

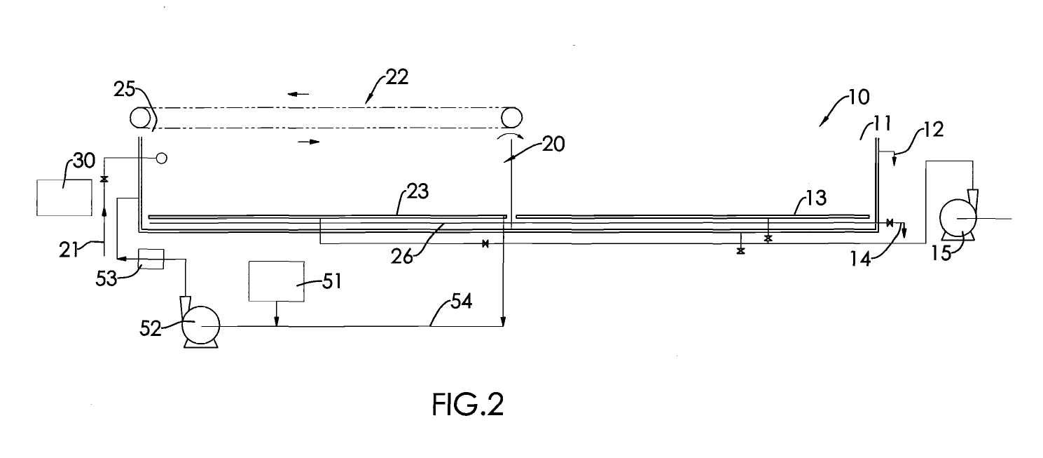

With reference to FIGS. 1 and 2, an agricultural sterilizing and detoxifying assembly in accordance with the present invention for vegetables and fruit comprises a rough-washing tank (10), a re-washing tank (20), a water-clarifying assembly (40), a sterilizing assembly, a packing platform (30) and a refrigerator (60).

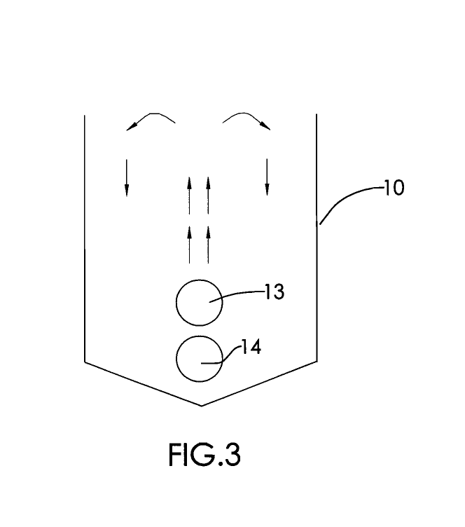

With further reference to FIG. 3, the rough-washing tank (10) has a chamber, a closed bottom, an open top (11), a sidewall, a water drainpipe (12), an aeration assembly and a sludge drainpipe (14). The closed bottom may be V-shaped. The open top (11) allows vegetables and fruit to be put into the chamber of the rough-washing tank (10). The water drainpipe (12) is mounted through the sidewall of the rough-washing tank (10) and communicates with the chamber of the rough-washing tank (10). The aeration assembly has an air pump (15) and an aeration pipe (13). The aeration pipe (13) is made of porous material, is mounted in the chamber of the rough-washing tank (10) near the closed bottom, is connected to the air pump (15) and has multiple pores. The pores allow air to be pumped through the aeration pipe (13), agitate water in the rough-washing tank (10) and turn the vegetables and fruit repeatedly so the vegetables and fruit will be washed thoroughly. Each pore has a dimension of 20-60 micrometers. The sludge drainpipe (14) is mounted through the rough-washing tank (10) below the aeration pipe (13) to remove sediment from the rough-washing tank (10).

The re-washing tank (20) communicates with and provides water to the rough-washing tank (10) and may abut the rough-washing tank (10) or be connected to the rough-washing tank (10) by a sluice pipe (24) with a pump and a valve. The re-washing tank (20) has a chamber, a closed bottom, an open top (25), a sidewall, an aeration pipe (23), a sludge drainpipe (26), a water inlet (21) and a conveyor belt (22). The closed bottom may be V-shaped. The open top (25) allows vegetables and fruit from the rough-washing tank (10) to be placed in the re-washing tank (20) so the vegetables and fruit will be washed again. When the re-washing tank (10) abuts the rough-washing tank (10), water may flow from the open top (25) of re-washing tank (20) directly into the rough-washing tank (10). The aeration pipe (23) is made of porous material, is mounted in the chamber of the re-washing tank (20) near the closed bottom, is connected to the air pump (15) and has multiple pores. The pores allow air to be pumped through the aeration pipe (23), agitate water in the re-washing tank (20) and turn the vegetables and fruit repeatedly so the vegetables and fruit will be washed thoroughly. Each pore has a dimension of 20-60 micrometers. The sludge drainpipe (26) is mounted in the chamber of the re-washing tank (20) near the closed bottom and is connected to the sludge drainpipe (14) of the rough-washing tank (10) to remove sediment from the re-washing tank (20). The water inlet (21) is formed through the sidewall of the re-washing tank (20), communicates with the chamber of the re-washing tank (20) and allows water to enter the re-washing tank (20). The conveyor belt (22) is meshed, is mounted above the open top (25) and allows vegetables and fruit to be put on the conveyor belt (22).

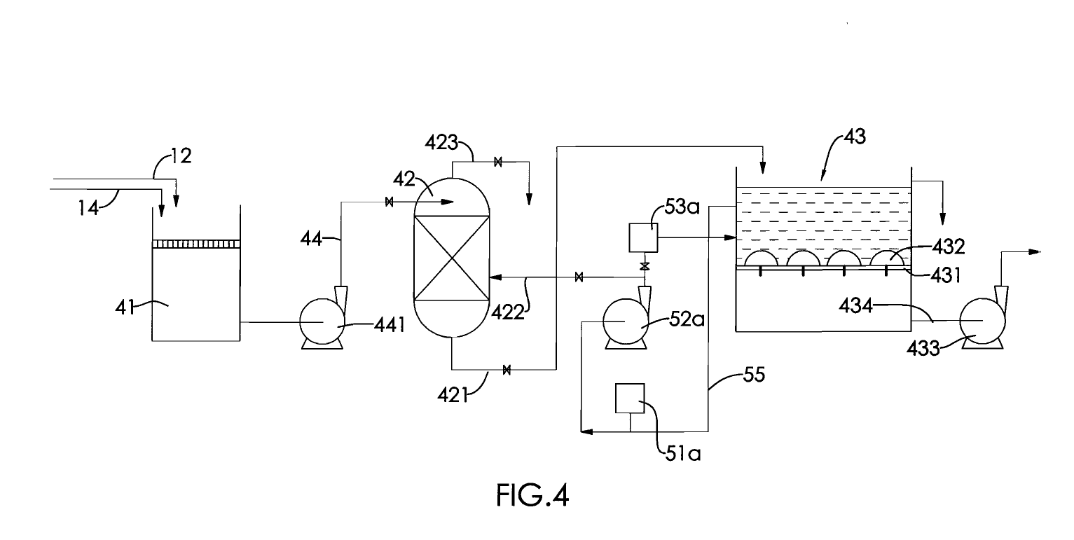

With further reference to FIG. 4, the water-clarifying assembly (40) is connected to the water drainpipe (12) and the sludge drainpipe (14), purifies waste water, recycles purified water to the re-washing tank (20) and has a sewage tank (41), a transfer pipe (44), a rough filter (42) and a purifier (43). The sewage tank (41) receives wastewater and sediment from the water drainpipe (12) and the sludge drainpipe (14). The transfer pipe (44) is connected to the sewage tank (41) and has a pump (441) and a distal end. The pump (441) pumps wastewater out of the sewage tank (41). The rough filter (42) is connected to the water drainpipe (12) and the sludge drainpipe (14), may be connected to the distal end of the transfer pipe (44), receives wastewater pumped from the sewage tank (41) and has at least one filter bed, a filtering outlet (421) and a backflow system. The filter bed filters suspended sediment from the wastewater. The backflow system is used to clean the rough filter (10) and remove sediment captured in the filter bed and has a backflow inlet (422) and backflow outlet (423). The purifier (43) receives filtrate from the filtering outlet (421) and has a chamber, a partition (431), multiple micro-filters (432), a purified water outlet (434), a recycling pump (433) and a removal apparatus. The partition (431) is mounted horizontally in the chamber of the purifier (43) below the filtering outlet (421). The micro-filters (432) are mounted in the chamber on the partition (431) and may be ceramic filters that filter suspended sediment with a dimension of more than 0.1 micrometers. The purified water outlet (434) is mounted in the chamber of the purifier (43) below the partition (431). The recycling pump (433) is connected to the purified water outlet (434) and pumps purified water from the purifier (43) to the re-washing tank (20). The removal apparatus can remove sediment floating on the water in the purifier (43).

The sterilizing assembly communicates with the re-washing tank (20) and the purifier (43) of the water-clarifying assembly (40), provides sterilized water to the re-washing tank (20) and the purifier (43) and has a re-washing pipe (54), a purifying pipe (55), two ozone generators (51, 51a), two high-pressure pumps (52, 52a) and two high-pressure emulsifying apparatuses (53, 53a). The re-washing pipe (54) is mounted between the sterilizing assembly and the re-washing tank (20) to allow water to flow from the re-washing tank (20) through the sterilizing assembly and back to the re-washing tank (20). The purifying pipe (55) is mounted between the sterilizing assembly and the purifier (43) to allow water to flow from the purifier (43) through the sterilizing assembly and back to the purifier (43). The ozone generators (51, 51a) are connected respectively to the re-washing pipe (54) and the purifying pipe (55) and inject ozone respectively into the re-washing pipe (54) and the purifying pipe (55) to react with water in the re-washing pipe (54) and the purifying pipe (55) and generate free radicals. Free radicals will breakdown insecticides and kill microorganisms in a few minutes. The high-pressure pumps (52, 52a) are connected respectively to the re-washing pipe (54) and the purifying pipe (55), are connected to the backflow inlet (422) to the rough filter (42) and pressurize water in the re-washing pipe (54) and the purifying pipe (55) to 5-10 kg/cm², so ozone in the water has a concentration of 0.5-10 mg/l. The high-pressure emulsifying apparatuses (53, 53a) are connected respectively to the high-pressure pumps (52, 52a), and the backflow inlet (422) is mounted between the high-pressure emulsifying apparatuses (53a) and the high-pressure pump (52a). The high-pressure emulsifying apparatuses (53, 53a) release micro-bubbles into the water. Surface tension of the micro-bubbles attracts and holds suspended solid so the micro-bubbles and suspended solids can be removed by the removal apparatus in the purifier (43).

The packing platform (30) communicates with the conveyor belt (22) to receive vegetables and fruit from the conveyor belt (22) so the vegetables and fruit can be packed into appropriate containers for shipping or storage.

The refrigerator (60) communicates with the rough-washing tank (10) to cool the water, so the vegetables and fruit will cool down and be preserved for a long time.

Vegetables and fruit can be washed in the rough-washing tank (10) first and then washed in the re-washing tank (20). The re-washing tank (20) has water full of ozone, free radicals and emulsified bubbles to breakdown insecticide and destroy microorganisms adhering to the vegetables and fruit. Sediment and wastewater flow to water-clarifying assembly (40) through the water drainpipe (12) and the sludge drainpipe (14), and purified water flows back to the re-washing tank (20) and rough-washing tank (10) to recycle the water.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An agricultural sterilizing and detoxifying assembly for vegetables and fruit comprising:
a rough-washing tank having
a chamber;
a closed bottom;
an open top;
a sidewall;
a water drainpipe mounted through the sidewall and communicating with the chamber;
an aeration assembly having
an air pump; and
an aeration pipe being mounted in the chamber of the rough-washing tank near the closed bottom and being connected to the air pump; and
a sludge drainpipe being mounted through the rough-washing tank below the aeration pipe;
a re-washing tank communicating with and adapted to provide water to the rough-washing tank and having
a chamber;
a closed bottom;
an open top;
a sidewall;
an aeration pipe being mounted in the chamber of the re-washing tank near the closed bottom and being connected to the air pump;
a sludge drainpipe being mounted in the chamber of the re-washing tank near the closed bottom of the re-washing tank and being connected to the sludge drainpipe of the rough-washing tank; and
a water inlet being formed through the sidewall of the re-washing tank and communicating with the chamber of the re-washing tank;
a water-clarifying assembly being connected to the water drainpipe and the sludge drainpipe, adapted to purify waste water and recycle purified water to the re-washing tank and having
a rough filter being connected to the water drainpipe and the sludge drainpipe and having
at least one filter bed filtering suspended sediment from the wastewater;
a filtering outlet; and
a backflow system having
a backflow inlet; and
a backflow outlet; and
a purifier receiving filtrate from the filtering outlet and having
a chamber;
multiple micro-filters being mounted in the chamber; and
a purified water outlet mounted in the chamber of the purifier; and
a recycling pump being connected to the purified water outlet and adapted to pump purified water from the purifier to the re-washing tank; and
a sterilizing assembly communicating with the re-washing tank and the purifier of the water-clarifying assembly, providing sterilized water to the re-washing tank and the purifier and having
a re-washing pipe being mounted between the sterilizing assembly and the re-washing tank;
a purifying pipe being mounted between the sterilizing assembly and the purifier;
two ozone generators being connected respectively to the re-washing pipe and the purifying pipe and injecting ozone respectively into the re-washing pipe and the purifying pipe;
two high-pressure pumps being connected respectively to the re-washing pipe and the purifying pipe, being connected to the backflow inlet to the rough filter and adapted to pressurize water in the re-washing pipe and the purifying pipe; and
two high-pressure emulsifying apparatuses being connected respectively to the high-pressure pumps and communicating with the purifier.

2. The agricultural sterilizing and detoxifying assembly for vegetables and fruit as claimed in claim 1, wherein the re-washing tank further has a conveyor belt being meshed and mounted above the open top of the re-washing tank.

3. The agricultural sterilizing and detoxifying assembly for vegetables and fruit as claimed in claim 1 further comprising a refrigerator communicating with the rough-washing tank.

4. The agricultural sterilizing and detoxifying assembly for vegetables and fruit as claimed in claim 1, wherein
the closed bottom of the rough-washing tank is V-shaped; and
the closed bottom of the re-washing tank is V-shaped.

5. The agricultural sterilizing and detoxifying assembly for vegetables and fruit as claimed in claim 1, wherein
the aeration pipe of the rough-washing tank is made of porous material; and
the aeration pipe of the re-washing tank is made of porous material.

6. The agricultural sterilizing and detoxifying assembly for vegetables and fruit as claimed in claim 1, wherein the re-washing tank abuts the rough-washing tank.

7. The agricultural sterilizing and detoxifying assembly for vegetables and fruit as claimed in claim 1, wherein the water-clarifying assembly further has
a sewage tank adapted to receive wastewater and sediment from the water drainpipe and the sludge drainpipe; and
a transfer pipe connected to the sewage tank and having
a pump adapted to pump wastewater out of the sewage tank; and
a distal end; and
the rough filter connected to the distal end of the transfer pipe.

8. The agricultural sterilizing and detoxifying assembly for vegetables and fruit as claimed in claim 1, wherein
the purifier further has a partition mounted horizontally in the chamber of the purifier below the filtering outlet; and
the micro-filters are mounted on the partition; and
the purified water outlet is mounted below the partition.

9. The agricultural sterilizing and detoxifying assembly for vegetables and fruit as claimed in claim 1, wherein the high-pressure pumps adapted to pressurize water in the re-washing pipe and the purifying pip to 5-10 kg/cm² so ozone in the water has a concentration of 0.5-10 mg/l.

10. The agricultural sterilizing and detoxifying assembly for vegetables and fruit as claimed in claim 2 further having a packing platform communicating with the conveyor belt.

11. The agricultural sterilizing and detoxifying assembly for vegetables and fruit as claimed in claim 5, wherein
the aeration pipe in the rough-washing tank is made of porous materials;
the aeration pipe in the re-washing tank is made of porous materials.
